(19) United States
(12) Patent Application Publication
(10) Pub. No.: US 2012/0329529 A1
(43) Pub. Date: Dec. 27, 2012

(54) GESTURE ACTIVATE HELP PROCESS AND SYSTEM

(75) Inventor: Krijn van der Raadt, San Diego, CA (US)

(73) Assignee: GreatCall, Inc., San Diego, CA (US)

(21) Appl. No.: 13/530,062

(22) Filed: Jun. 21, 2012

Related U.S. Application Data
(60) Provisional application No. 61/499,525, filed on Jun. 21, 2011.

(51) Int. Cl. G06F 3/03; G06F 3/041; H04W 88/02

(52) U.S. Cl. 455/566

(57) ABSTRACT

A cellular phone with gesture detection is used to more effectively activate a multi-tier help system. Initially, a shake gesture is used to activate a context-sensitive help screen. Help can progress to a tier that includes interaction with a human customer service representative called from the cellular phone.

This application claims the benefit of U.S. Provisional Patent Application No. 61/499,525, filed Jun. 21, 2011 and titled “Gesture Activate Help Process and System”, the entire disclosure of which is hereby incorporated by reference herein for all purposes.

### SUMMARY

According to one aspect, a handheld computing device for providing mobile computing and other functions includes a movement sensor for signaling a gesture of a user of the handheld computing device, a memory for storing software, a screen for displaying information, a communications channel another device, and a processor for executing the software. The software is programmed to detect a predetermined gesture of the user, present context-sensitive help information when the predetermined gesture is detected, and activate the communication channel to the other device. In some embodiments, the context-sensitive help is presented on the screen of the handheld computing device. In some embodiments, the context-sensitive help is presented in the form of audio instructions that are played by the handheld computing device. The software may be programmed to detect another gesture that deactivates the context-sensitive help. In some embodiments, the handheld computing device for providing mobile computing and other functions further includes a haptic feedback element that creates movement in the handheld computing device to acknowledge that the predetermined gesture was recognized. The predetermined gesture may be a shaking movement of the handheld computing device. The handheld computing device may be a cellular telephone. In some embodiments, the predetermined gesture both triggers the context-sensitive help information and cancels the context-sensitive help. In some embodiments, the context-sensitive help is presented in an overlay window on the screen. In some embodiments, the context-sensitive help is canceled by touching the screen in a predetermined area.

### BRIEF DESCRIPTION OF THE DRAWINGS

FIG. 1 shows an embodiment of a communication system.

FIG. 1A illustrates a system according to another embodiment.

FIG. 2 illustrates a block diagram of a system in accordance with embodiments.

FIG. 3 illustrates a flow chart of a process for providing help to users, in accordance with embodiments.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

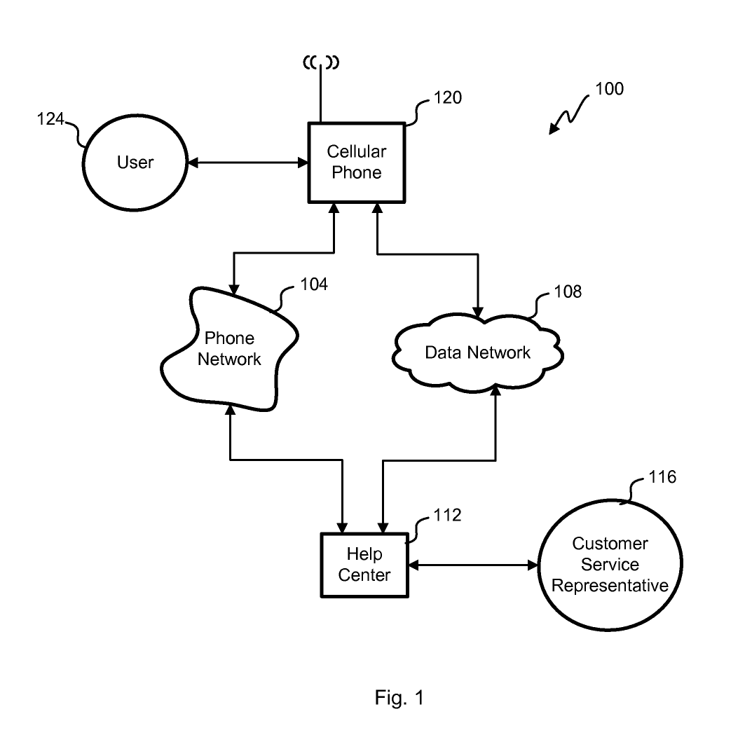

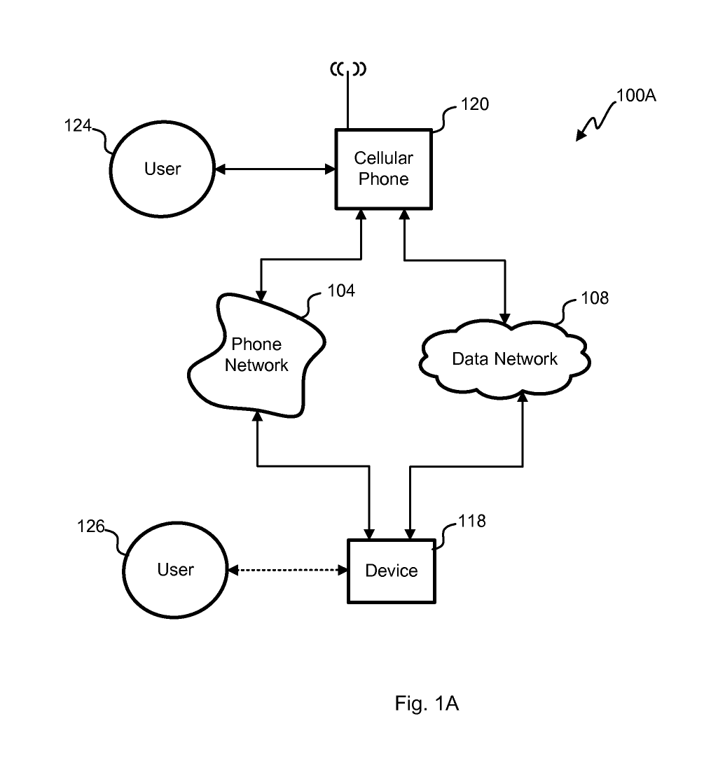

Referring initially to FIG. 1, an embodiment of a communication system 100 is shown in a simplified form. A help center 112 is available over phone and data networks 104, 108 to allow a user 124 of a cellular phone 120 receive assistance in an automated and human-assisted manner. Although a single cellular telephone, user and customer service representative (CSR) are shown, it is to be understood that many would exist in a typical implementation.

The cellular phone 120 includes an application that provides functionality, for example, health coaching, customer service, billing information, medication reminders, personal security, concierge service, etc. The application can be built-into the cellular phone or downloaded after deployment to the field. In one embodiment, the user 124 downloads the application from an application store accessible from the cellular phone 120. In other embodiments, the cellular phone could be a pad, tablet, camera, game controller, medical alert fob, emergency notification device, information device, car key, or other handheld communication device.

The phone network 104 is used to call the user 124 should automated help not solve an issue. The cellular phone 120 could call the help center or the help center could call the cellular phone 120. Some embodiments may forgo the phone network 104 for voice communication in favor of VoIP or a digital walkie-talkie feature of the application.

A data network is used to communicate status of the application and user interaction with the cellular phone 120. Answers to automated questions and queries on the phone could also be relayed back to the help center 112 using the data network. Some of the help information displayed on the cellular phone is found using the data network 108 to query the help center 112 in real time. The answers to queries could be automatic or provided with human assistance that is displayed on a screen of the cellular phone through a chat window.

A CSR 116 interacts with the help center 112 locally or remotely to assist the user when automated help resident on the phone is not able to solve a problem. This help can be hand selecting answers after remote viewing of a user's screen and interaction, chat communication or phone communication. The software on the cellular phone 120 logs all interaction immediately before (e.g., the prior 30 sec., 1 min., 5 min.) the help workflow was activated and after activation. The CSR has a tool where the cellular phone screen can be viewed in real time or rewound to any time before that and even before help was activated.

With reference to FIG. 1A, another embodiment of this invention is shown as system 100A. In this embodiment, cellular phone 120 communicates with another device 118 which is situated at a specific location. For example, device 118 could be an information terminal at a zoo or a tradeshow. By shaking cellular phone 120, user 124's location is sent to a server via data network 108. The server correlates user 124's location with the location of device 118. Device 118 would then play an audio with relevant information about the particular exhibit. Alternatively, device 118 could be located at a restaurant, a store, or a company, in which case, the device would reply via text message or voice or alternative method with location specific information such as restaurant menus, store specific coupons, or information about a particular company. If device 118 is located for example in a cab stop, shaking the device could enable a taxi to know that a ride is requested.

Alternatively, device 118 could be a device carried by another person or located in an organization. By shaking cellular phone 120, the user could place a call to an emergency call center or 911 to request help. In this case, device 118 would be located in the call center itself and would be answered by user 126, who is the emergency call operator. In another embodiment, device 118 could belong to a person in user 124's “trusted network,” so user 126 would be a friend, family member, colleague, or otherwise trusted person. By shaking cellular phone 120 user 124 would open communications with all or a subset of the people in his trusted network. This communication would occur through phone network 104 or data network 108, and would consist of a cellular broadcast technology, push to talk (PTT) technology, or other voice or data technology. In this way user 124 can communicate directly with multiple people by shaking his cellular phone 120.

Yet another embodiment of this invention involves finding or locating “trusted devices”. For example, by shaking cellular phone 120, device 118, which is a trusted device, such as a car key, cell phone, car, or other device would respond with a chirp or other audio sound. In this way, if user 124 has misplaced his keys, he can shake cellular phone 120, which would cause his keys (device 118) to respond by emitting an audio sound. User 124 could preset a number of trusted devices which would respond to the gesture of cellular phone 120.

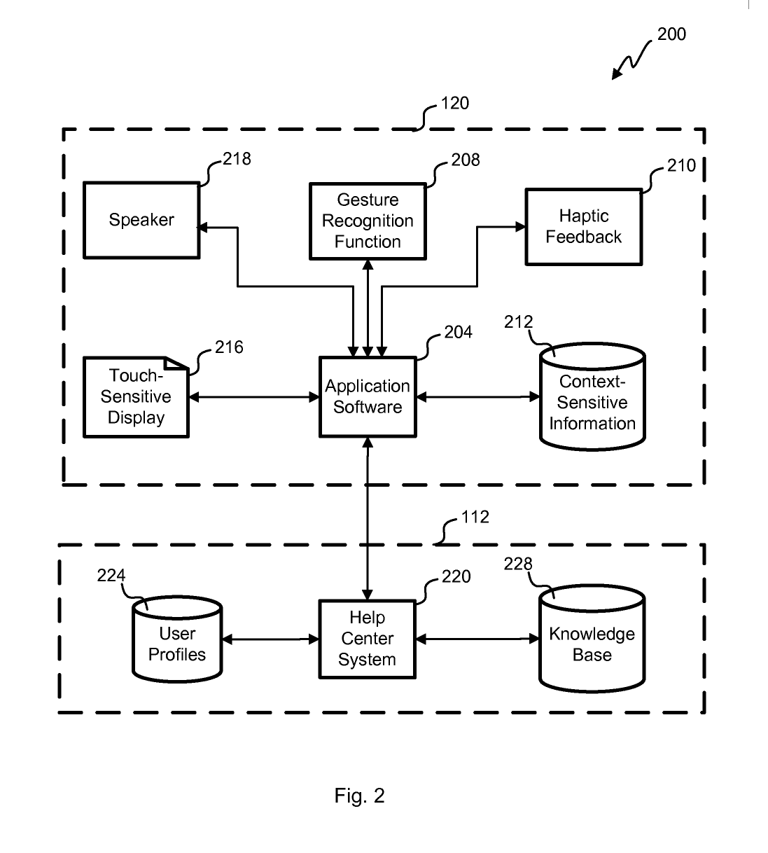

With reference to FIG. 2, an embodiment of a block diagram of the help system 110 is shown in detail for the cellular phone 120 and the help center 112. The cellular phone 120 includes application software 204, but other embodiments could place the software in the operating system.

The application software 204 has access to a gesture recognition feature 208. In this embodiment, the gesture recognition feature is an orientation sensor (e.g., a gravity switch, accelerometer and/or gyroscope) that can detect a shake gesture where the phone is moved back in forth in a predetermined way. Other embodiments could use other gestures (e.g., raising one's hand, a rotating gesture, several flips of the phone, etc.) Normal movement of the cellular phone 120 is filtered such that false detections are kept to a minimum. Other embodiments could use an embedded camera to detect gestures or voice recognition could be used.

Some embodiments may include a feedback feature. In this embodiment, haptic feedback 210 is provided through a movement transducer that vibrates when the gesture is recognized. This is done to supplement a window or bubble on the touch-sensitive display 216. Other embodiments could provide a sound or voice confirmation when help is activated through the gesture. Once activated, the user can touch an area of the display 216 outside the help window or a close button to exit help. Other embodiments allow a second gesture to exit help. In this embodiment, shaking will also exit help after activated. If the shaking causes a false activation, the continued shaking will close down the help.

An expert system of automated help is provided that is context-sensitive. Based upon the user's current place in the application and/or historical interaction, the context-sensitive information 212 is referenced and appropriate information is provided in the help window. Other embodiments provide the context-sensitive information via audio instructions that may be played using the speaker 218. Presumptions are made about the expertise level of the user 124 such that help is not given for features that the user has successfully used in the past. Additionally, the skill level of the user 124 is scored based upon past interaction such that answers appropriate for that skill level are provided.

In the help center 112, a help center system 220 has access to user profiles 224. The user profiles have demographic information on the user 124, skill level, expertise level, and other historical information. Additionally, information entered into the application software 204 is available. For example, a medication coaching application would include the medication regimen, doctor information, pharmacy information, etc. for the user 124. All that is available along with a knowledge base 228 of answers to commonly occurring issues.

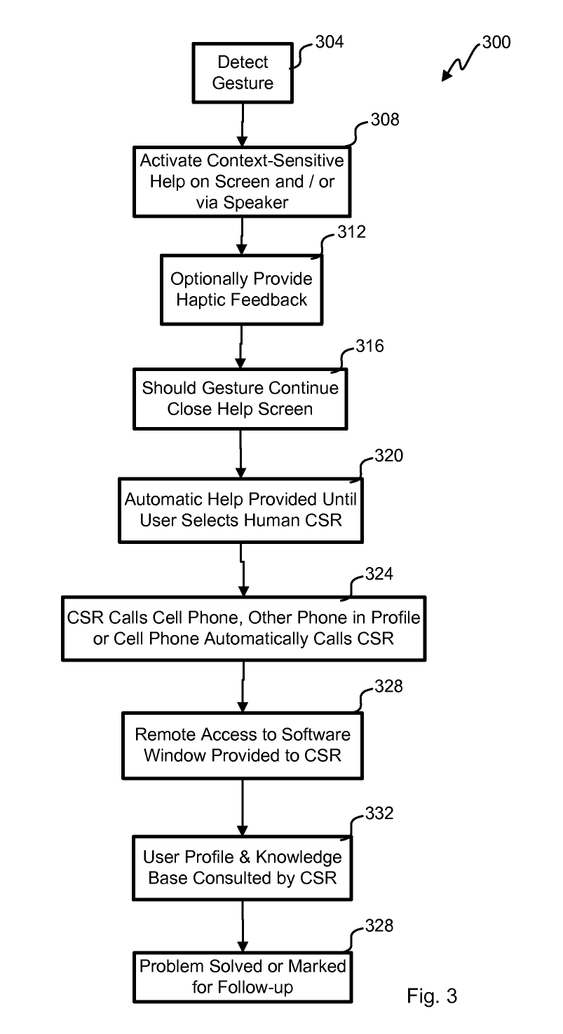

Referring next to FIG. 3, an embodiment of a process 300 for providing help to users 124 is shown. The depicted portion of the process 300 begins in block 304 where the gesture predetermined to activate help is detected. The help information is presented on the display 216 and/or via the speaker 218 after determining the context to provide a good suggestion from the context-sensitive information 212 in block 308. Optionally, haptic feedback 210 is provided to let the user 124 know that help has been activated in block 312. Should the gesture continue or another predetermined gesture happen, the help screen and workflow would cease in block 316.

Automatic help is provided through interaction with the cellular phone 120 in block 320. Ultimately, automatic help may not solve the problem and the user 124 can elevate the process to receiving communication from a human CSR. The interaction could be chat initially or a phone call. In block 324, the CSR calls the cellular phone 120 or another phone in the user profile 224, or the cellular phone 120 calls the CSR. Remote access software provides a screen scrape of the display in real time in block 328. Additionally, historical displays are available through a rewind feature that lists all the interaction along a timeline as the CSR manipulates the timeline.

The problem is hopefully solved through interaction with the user profile 224, knowledge base 228 and discussion with the user 124 in block 332. Where unsuccessful, the problem is marked for remedial action, elevation or other follow-up. In this way, a cellular phone user 124 can easily activate a help workflow that uses both automatic and manual techniques with a rich environment of information to quickly solve any problem that might occur with software 204 in this embodiment.

While the principles of the disclosure have been described above in connection with specific apparatuses and methods, it is to be clearly understood that this description is made only by way of example and not as limitation on the scope of the disclosure.

1. A handheld computing device for providing mobile computing and other functions, the handheld computing device comprising:
a movement sensor for signaling a gesture of a user of the handheld computing device;
a memory for storing software;
a screen for displaying information;
a communications channel to another device; and
a processor for executing the software, wherein the software is programmed to:
detect a predetermined gesture of the user,
present context-sensitive help information when the predetermined gesture is detected, and
activate the communication channel to the other device.

2. The handheld computing device for providing mobile computing and other functions as recited in claim 1, wherein the context-sensitive help is presented on the screen of the handheld computing device.

3. The handheld computing device for providing mobile computing and other functions as recited in claim 1, wherein the context-sensitive help is presented in the form of audio instructions that are played by the handheld computing device.

4. The handheld computing device for providing mobile computing and other functions as recited in claim 1, wherein the software is programmed to detect another gesture that deactivates the context-sensitive help.

5. The handheld computing device for providing mobile computing and other functions as recited in claim 1, further comprising a haptic feedback element that creates movement in the handheld computing device to acknowledge that the predetermined gesture was recognized.

6. The handheld computing device for providing mobile computing and other functions as recited in claim 1, wherein the predetermined gesture is a shaking movement of the handheld computing device.

7. The handheld computing device for providing mobile computing and other functions as recited in claim 1, wherein the handheld computing device is a cellular telephone.

8. The handheld computing device for providing mobile computing and other functions as recited in claim 1, wherein the predetermined gesture both triggers the context-sensitive help information and cancels the context-sensitive help.

9. The handheld computing device for providing mobile computing and other functions as recited in claim 1, wherein the context-sensitive help is presented in an overlay window on the screen.

10. The handheld computing device for providing mobile computing and other functions as recited in claim 1, wherein the context-sensitive help is canceled by touching the screen in a predetermined area.

11. The handheld computing device for providing mobile computing and other functions as recited in claim 1, wherein the communications channel to the other device is a telephone network.

12. The handheld computing device for providing mobile computing and other functions as recited in claim 1, wherein the communications channel to the other device is a data network.

13. A method of providing help to a user of a handheld computing device, the method comprising:
recognizing, by the handheld computing device, that the handheld computing device is the subject of a particular movement;
presenting help information to a user of the handheld computing device; and
connecting to another device through a communications channel.

14. The method of providing help to a user of a handheld computing device as recited in claim 13, wherein the help information is context-sensitive.

15. The method of providing help to a user of a handheld computing device as recited in claim 13, further comprising:
determining the location of the handheld computing device;
transmitting the location to the other device; and
receiving the help information for presentation to the user, wherein the help information is selected based at least in part on the location of the handheld computing device.

16. The method of providing help to a user of a handheld computing device as recited in claim 13, further comprising filtering normal movement of the handheld computing device.

17. The method of providing help to a user of a handheld computing device as recited in claim 13, further comprising communicating to the other device a status of the user's interaction with the handheld computing device.

18. The method of providing help to a user of a handheld computing device as recited in claim 17, further comprising logging all user interaction with the handheld computing device for a preselected interval before recognizing that the handheld computing device is the subject of the particular movement.

19. The method of providing help to a user of a handheld computing device as recited in claim 13, further comprising providing haptic feedback to the user to indicate that the particular movement has been recognized.

20. A method of providing help to a user of a handheld computing device, the method comprising:
recognizing, by the handheld computing device, that the handheld computing device is the subject of a particular movement;
determining the location of the handheld computing device; and
presenting help information to a user of the handheld computing device, wherein the help information is selected based at least in part on the location of the handheld computing device.

21. The method of claim 20, further comprising:
connecting to another device through a communications channel;
transmitting the location to the other device; and
receiving at least some of the help information from the other device.

22. The method of claim 20, wherein presenting the help information to the user of the handheld computing device comprises playing audio information.
